(19) United States
(12) Patent Application Publication
(10) Pub. No.: US 2011/0089935 A1
(43) Pub. Date: Apr. 21, 2011

(54) MAGNETIC ENCODER WITH OFFSET ADJUSTMENT FUNCTION

(75) Inventors: Mitsuyuki TANIGUCHI, Yamanashi (JP); Hirofumi KIKUCHI, Yamanashi (JP); Tokuhisa MATSUKANE, Yamanashi (JP)

(73) Assignee: FANUC LTD, Yamanashi (JP)

(21) Appl. No.: 12/837,531

(22) Filed: Jul. 16, 2010

(30) Foreign Application Priority Data
Oct. 21, 2009 (JP) 2009-242571

(51) Int. Cl. G01B 7/30

(52) U.S. Cl. 324/207.25

(57) ABSTRACT

A center voltage of an analog signal from a magnetic sensor is measured to match a reference voltage with the center voltage. Then, a combination of portions to be disconnected of adjustment patterns 1 and 2 of adjustment circuits 1 and 2 is determined so that the reference voltage is adjusted to the measured center voltage, and the portions are disconnected. The adjustment circuits 1 and 2 respectively include recovery patterns 1 and 2. If an adjustment pattern 1 and 2 is erroneously disconnected, the corresponding recovery pattern 1 and 2 is short-circuited by means of soldering or the like to short-circuit the adjustment pattern 1 and 2 once again.

### BACKGROUND OF THE INVENTION

1. Field of the Invention

The present invention relates to a magnetic encoder capable of performing reference voltage offset adjustment.

2. Description of the Related Art

Optical encoders and magnetic encoders are used in various fields to detect a correct position of a moving object that moves linearly or a moving object that rotates. Magnetic encoders have simple structure and are resistant to environmental conditions such as water and oil. A magnetic encoder mainly includes an object to be detected having a concave-convex surface like a gear and a magnetic sensor positioned to face the object to be detected.

In a conventional art, as shown in FIG. 8, an analog signal 20 output from a magnetic sensor 10 is compared with a reference voltage 21 and converted into a digital signal 22 by a comparator 7.

Typically, an offset occurs between a center voltage of the analog signal 20 from the magnetic sensor 10 and the reference voltage 21 due to characteristics of passive devices constituting a signal processing circuit, as shown in FIG. 3.

Accordingly, in order to adjust the reference voltage 21 to the center voltage of the analog signal 20 from the magnetic sensor 10, the center voltage of the analog signal 20 from the magnetic sensor 10 is measured, and a resistance of a resistance voltage dividing circuit of a reference voltage circuit, which include a first resistor 1, a second resistor 2 and a replacement resistor for adjustment 8, is selected so that the reference voltage 21 becomes the same voltage as the measured center voltage. Then, a replacement resistor for adjustment 8 corresponding to the selected resistance of the resistance voltage dividing circuit is mounted on a circuit board (not shown). Therefore, there are disadvantages that many replacement resistors for adjustment 8 corresponding to various resistances need to be prepared, soldering work for mounting the selected replacement resistor for adjustment 8 on the circuit board is required, and further a number of processes are required to replace the replacement resistor for adjustment 8 when the resistance of the mounted replacement resistor for adjustment 8 should be changed.

There is also a technique in which a variable resistor 9 is used, as shown in FIG. 9, instead of replacing a replacement resistor for adjustment. Similarly, in this case, the center voltage of the analog signal 20 from the magnetic sensor 10 is measured, and the resistance of the variable resistor 9 is set so that the reference voltage 21 becomes the same voltage as the center voltage of the analog signal 20 from the magnetic sensor 10.

There is also a technique in which a resistor for fine adjustment is mounted in advance on a circuit board. Japanese Patent Application Laid-Open No. 2006-331178 discloses a technique of connecting in advance a fine adjustment resistor and a pair of lands for short-circuiting in parallel, and appropriately soldering the lands for short-circuiting to perform voltage adjustment. In this technique, however, soldering work has to be performed for adjusting the resistance, which results in troublesome process.

Japanese Patent Application Laid-Open No. 8-35897 discloses a technique of using at least two resistors as zero point adjustment resistors for an output voltage, wiring the zero point adjustment resistors both in series and in parallel with a conductor, and changing a disconnection portion of the conductor to obtain the connection of the zero point adjustment resistors in series or in parallel depending on the device type. In this technique, however, it is unknown what can be done if the conductor is erroneously disconnected in adjusting the resistance, and it is difficult to set an optimum resistance.

As described above, preparing a number of fine adjustment resistors for adjusting the reference voltage disadvantageously results in an increased cost and increased number of processes for replacement of the resistors.

### SUMMARY OF THE INVENTION

In view of the above disadvantages of the conventional techniques, an object of the present invention is to provide a magnetic encoder capable of performing reference voltage offset adjustment.

The present invention relates to a magnetic encoder with an offset adjustment function, which is attached to a motor or to a driven object driven by a motor and configured to detect a position or a speed of the motor or the driven object, the magnetic encoder including: a magnetic sensor; a voltage dividing resistor for dividing a power supply voltage used to determine an initial voltage value of a reference voltage; a fine adjustment resistor or a plurality of adjustment resistors arranged in series for adjusting the reference voltage to a center voltage of an analog signal from the magnetic sensor; and a pattern or patterns on a surface of a printed circuit board, which initially short-circuit both ends of the fine adjustment resistor or resistors. The pattern or patterns are appropriately disconnected to adjust the reference voltage to the center voltage of the analog signal, thereby allowing an offset adjustment of the reference voltage.

The magnetic encoder may further include pads arranged at both ends of the fine adjustment resistor or resistors, for resuming short-circuiting of both ends of the fine adjustment resistor or resistors for which the pattern or patterns are disconnected.

According to the above-described configuration, the present invention can provide a magnetic encoder capable of performing reference voltage offset adjustment.

### BRIEF DESCRIPTION OF THE DRAWINGS

FIG. 1 is an explanatory diagram of an adjustment circuit used in a magnetic encoder according to the present invention;

FIG. 2 is an explanatory diagram showing an example in which the adjustment circuit of FIG. 1 is used for reference voltage offset adjustment in the magnetic encoder;

FIG. 3 is a graph for explaining a relation of an analog signal from a magnetic sensor in FIG. 2, particularly a center voltage of the analog signal, and a reference voltage;

FIG. 4 is a diagram for explaining series arrangement of n (n≧2) adjustment circuits according to an adjustment range and allowable voltage;

FIG. 5 is a table for adjustment of resistance, which shows respective disconnection portions of adjusting patterns when a range of the center voltage of the analog signal from the magnetic sensor is A, B, C and D;

FIG. 6 is a diagram for explaining a relation between a voltage and an adjustment range;

FIG. 7 is a diagram for explaining an example of a circuit configured to adjust a reference voltage, in which two adjustment circuits are connected in series;

FIG. 8 is a diagram for explaining an offset adjustment function of an encoder according to a conventional art that selectively mounts a resistor; and

FIG. 9 is a diagram for explaining an offset adjustment function of an encoder according to a conventional art using a variable resistor.

### DETAILED DESCRIPTION OF THE PREFERRED EMBODIMENTS

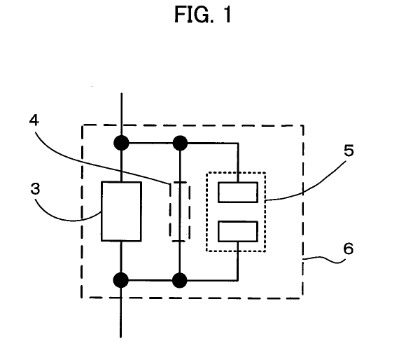

FIG. 1 is an explanatory diagram of an adjustment circuit used in a magnetic encoder according to the present invention.

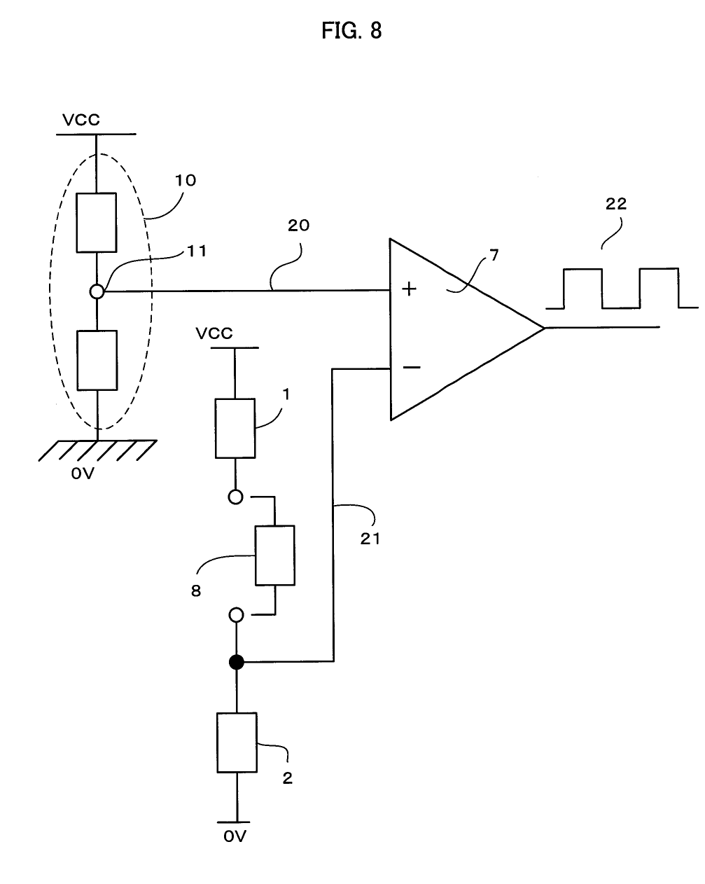

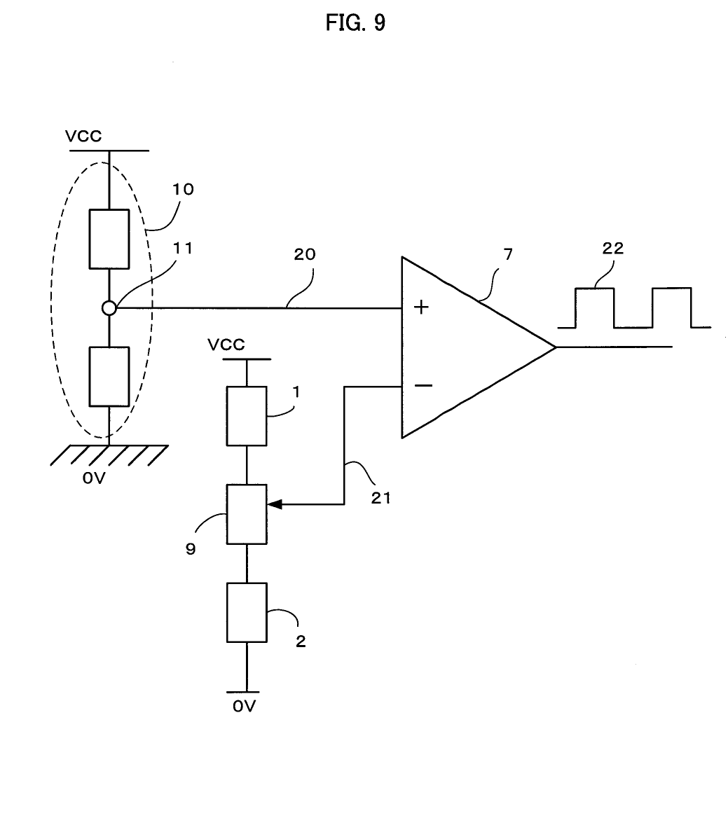

An adjustment circuit 6 shown in FIG. 1 is a circuit used for adjustment of a reference voltage and corresponds to a circuit that serves as the replacement resistor for adjustment 8 or the variable resistor 9 described above with reference to FIGS. 8 and 9. The adjustment circuit 6 is formed on a printed-circuit board (not shown) and includes an adjustment resistor 3, an adjustment pattern 4 and a recovery pattern 5. Each of the adjustment pattern 4 and the recovery pattern 5 is connected in parallel with the adjustment resistor 3.

The adjustment resistor 3 is a resistor corresponding to the replacement resistor for adjustment 8 in the circuit shown in FIG. 8 or the variable resistor 9 in the circuit shown in FIG. 9. The adjustment pattern 4 is a conductive pattern connected to both ends of the adjustment resistor 3 and configured to short-circuit the adjustment resistor 3. The adjustment pattern 4 is formed on a surface of the printed circuit board (not shown) on which the adjustment circuit 6 is formed, and is disconnected by disconnection means (not shown) so as to adjust the reference voltage 21 (FIG. 8). The recovery pattern 5 is composed of a pair of patterns or a pair of pads for resuming short-circuiting of the adjustment resistor 3 after the adjustment pattern 4 for short-circuiting is disconnected.

For example, the adjustment resistor 3, the adjustment pattern 4 and the recovery pattern 5 may be arranged such that the adjustment pattern 4 is arranged on one side of the adjustment resistor 3, and the recovery pattern 5 is arranged on the other side of the adjustment resistor 3 so that the adjustment pattern 4 is placed between the adjustment resistor 3 and the recovery pattern 5. Alternatively, the positions of the adjustment pattern 4 and the recovery pattern 5 may be replaced by each other. Since soldering is performed to short-circuit the recovery pattern 5, the arrangement shown in FIG. 1 in which the recovery pattern 5 is placed away from the adjustment pattern 4 is preferable in order to prevent the adjustment resistor 3 from being damaged by the heat generated in the recovery process. The adjustment resistor 3, the adjustment pattern 4 and the recovery pattern 5 may be formed on the same surface of the printed circuit board (not shown), or the adjustment pattern 4 and the recovery pattern 5 may be formed on a surface opposite to a surface on which the adjustment resistor 3 is formed.

By arranging the adjustment pattern 4 and the recovery pattern 5 composed of patterns or pads for recovery in parallel with the adjustment resistor 3, the operator can easily adjust the reference voltage. Even if the adjustment pattern 4 is erroneously disconnected in the adjustment operation, the short-circuit state of the adjustment resistor 3 can be recovered by short-circuiting the recovery pattern 5 by means of soldering.

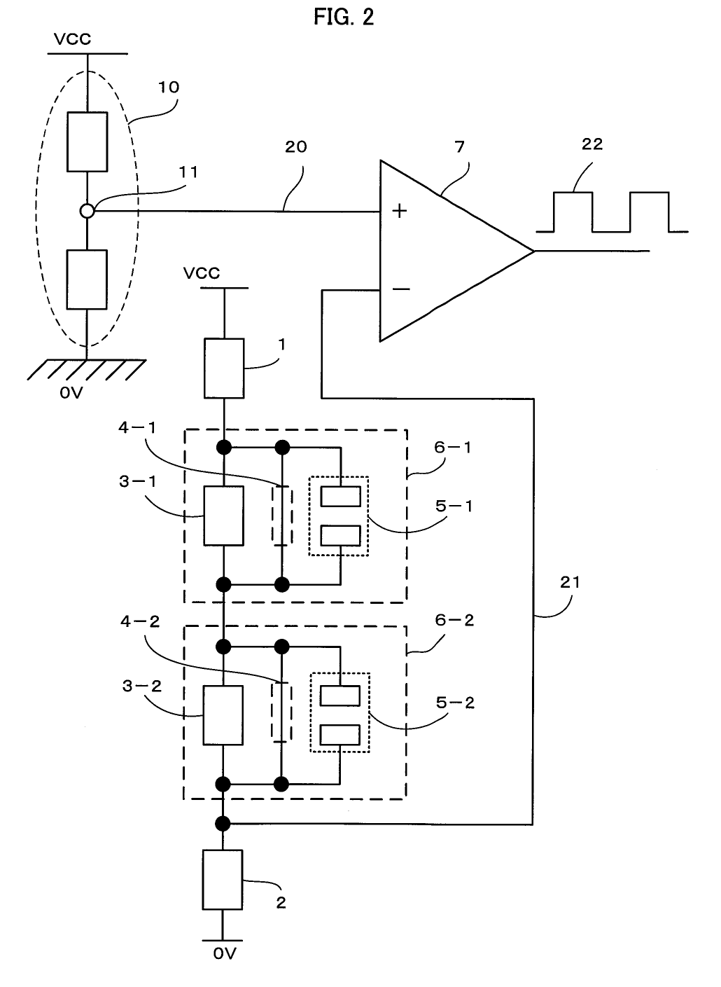

Next, an embodiment in which the adjustment circuit 6 of FIG. 1 is used for reference voltage offset adjustment in a magnetic encoder will be described with reference to FIG. 2.

In this embodiment, two adjustment circuits 6 (a first adjustment circuit 6-1 and a second adjustment circuit 6-2 in FIG. 2) are connected in series with a first resistor 1 and a second resistor 2. An analog signal 20 output from a terminal 11 of a magnetic sensor 10 is input to a plus terminal of a comparator 7.

The first resistor 1, the first adjustment circuit 6-1, the second adjustment circuit 6-2 and the second resistor 2 constitute an offset adjustment circuit for reference voltage 21. A power supply voltage is applied to the offset adjustment circuit. The reference voltage 21 is obtained from a portion connecting an adjustment resistor 3-2 of the adjustment circuit 6-2 and the second resistor 2. The reference voltage 21 is input to a minus terminal of the comparator 7. The comparator 7 compares the analog signal 20 from the magnetic sensor 10 with the reference voltage 21 and outputs a digital signal 22.

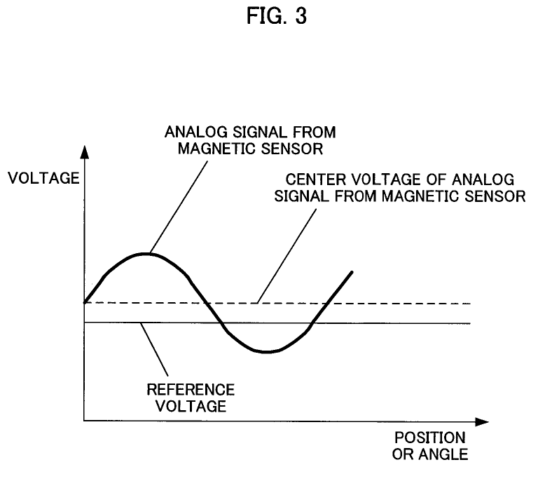

FIG. 3 is a graph for explaining an analog signal 20 from the magnetic sensor 10 in FIG. 2 and relation between a center voltage of the analog signal 20 and the reference voltage 21.

As shown in FIG. 2, by using two adjustment circuits 6 (the first adjustment circuit 6-1 and the second adjustment circuit 6-2), a difference between the center voltage of the analog signal 20 and the reference voltage 21, if any, can be eliminated.

In order to match the center voltage of the analog signal 20 from the magnetic sensor 10 with the reference voltage 21 in the circuit shown in FIG. 2, the center voltage of the analog signal 20 is measured, a combination of portions to be disconnected in an adjustment pattern 4-1 of the first adjustment circuit 6-1 and/or an adjustment pattern 4-2 of the second adjustment circuit 6-2 is determined so that the reference voltage 21 is adjusted to the center voltage of the analog signal 20, and the determined portions are disconnected.

As described above, the first and second adjustment circuits 6-1 and 6-2 include recovery patterns 5-1 and 5-2, respectively. Thus, if the adjustment patterns 4-1 and 4-2 are erroneously disconnected, adjustment resistors 3-1 and 3-2 are short-circuited once again by short-circuiting the recovery patterns 5-1 and 5-2 by means of soldering or the like.

The magnetic encoder typically includes an object to be detected (not shown) having a concave-convex surface like a gear and the magnetic sensor 10 arranged to face the object to be detected, as described above. The magnetic encoder is a known encoder.

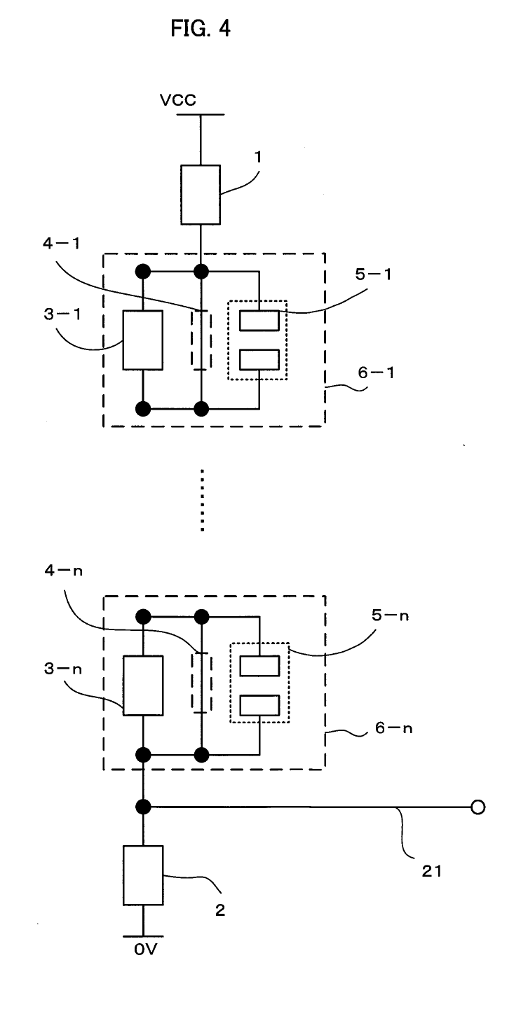

FIG. 4 is a diagram for explaining series arrangement of n (n≧2) adjustment circuits 6-1, 6-2, . . . and 6-n according to an adjustment range and allowable voltage.

A circuit in which the first resistor 1 and the second resistor 2 for dividing the power supply voltage to determine an initial voltage value of the reference voltage 21 as well as n adjustment circuits 6-1, 6-2, . . . and 6-n are arranged in series is used in order to match the center voltage of the analog signal 20 from the magnetic sensor 10 with the reference voltage 21. The number n of the adjustment circuits is determined based on an adjustment range required and an allowable voltage difference. The adjustment circuits 6-1, 6-2, . . . and 6-n are combinations of adjustment resistors 3-1, 3-2, . . . and 3-n for adjusting the divided voltages, adjustment patterns 4-1, 4-2, . . . and 4-n for short-circuiting both ends of the respective adjustment resistors, and recovery patterns 5-1, 5-2, . . . and 5-n composed of patterns or pads for resuming short-circuiting after the adjustment patterns are disconnected, respectively.

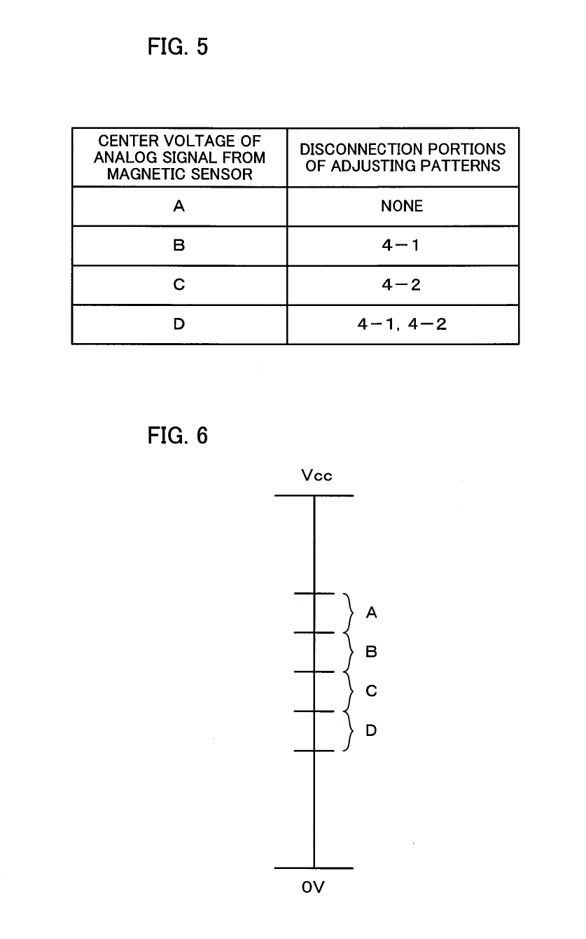

FIG. 5 is a table for adjustment of resistance, which shows respective disconnection portions of corresponding adjusting patterns when a range of the center voltage of the analog signal from the magnetic sensor is A, B, C and D.

FIG. 6 is a diagram for explaining the relation between the voltage and the adjustment range.

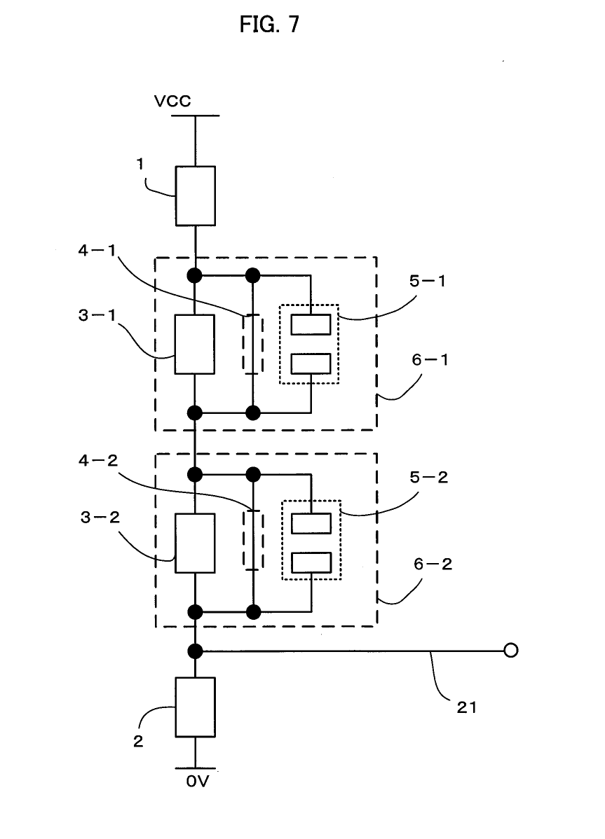

FIG. 7 is a diagram for explaining an example of a circuit configured to adjust the reference voltage 21, in which two adjustment circuits 6-1, 6-2 are connected in series. A method of adjusting a resistance in the example of FIG. 7 will be described below.

First, the center voltage of the analog signal 20 from the magnetic sensor 10 is measured. Then, it is determined which of the ranges A, B, C and D of FIG. 6 the measured center voltage belongs to. If determined that the center voltage belongs to the range B, the table of FIG. 5 shows that the portion to be disconnected is the adjustment pattern 4-1 of the first adjustment circuit 6-1 shown in FIG. 7.

Next, a process for dealing with a case where the adjustment pattern 4 is erroneously disconnected in the circuit configured to adjust the reference voltage 21 shown in FIG. 7 will be described.

If the adjustment pattern 4-2 of the second adjustment circuit 6-2 is erroneously disconnected when the center voltage of the analog signal 20 from the magnetic sensor 10 is in the range B and thus the adjustment pattern 4-1 of the first adjustment circuit 6-1 should be disconnected based on the table of FIG. 5, the recovery pattern 5-2 of the second adjustment circuit 6-2 is short-circuited by means of soldering or the like, and the adjustment pattern 4-1 is disconnected.

As described above, by arranging an adjustment pattern for short-circuiting and a recovery pattern for short-circuiting again in parallel with a resistor for fine adjustment of a resistance in a circuit for adjusting a reference voltage, an operator can smoothly perform the reference voltage offset adjustment.

1. A magnetic encoder with an offset adjustment function, which is attached to a motor or to a driven object driven by a motor and configured to detect a position or a speed of the motor or the driven object, the magnetic encoder comprising:
a magnetic sensor;
a voltage dividing resistor for dividing a power supply voltage used to determine an initial voltage value of a reference voltage;
a fine adjustment resistor or a plurality of adjustment resistors arranged in series for adjusting the reference voltage to a center voltage of an analog signal from the magnetic sensor; and
a pattern or patterns on a surface of a printed circuit board, which initially short-circuit both ends of the fine adjustment resistor or resistors, wherein
the pattern or patterns are appropriately disconnected to adjust the reference voltage to the center voltage of the analog signal, thereby allowing an offset adjustment of the reference voltage.

2. The magnetic encoder with an offset adjustment function according to claim 1, further comprising pads arranged at both ends of the fine adjustment resistor or resistors, for resuming short-circuiting of both ends of the fine adjustment resistor or resistors for which the pattern or patterns are disconnected.
